(19) United States
(12) Patent Application Publication
(10) Pub. No.: US 2022/0126583 A1
(43) Pub. Date: Apr. 28, 2022

(54) LIQUID DISCHARGE HEAD, LIQUID DISCHARGE DEVICE, AND ACTUATOR

(71) Applicant: SEIKO EPSON CORPORATION, Tokyo (JP)

(72) Inventors: Masaki MORI, Shiojiri-shi (JP); Motoki TAKABE, Shiojiri-shi (JP)

(21) Appl. No.: 17/452,078

(22) Filed: Oct. 25, 2021

(30) Foreign Application Priority Data
Oct. 26, 2020 (JP) 2020-178709

(51) Int. Cl. B41J 2/16; B41J 2/14

(52) U.S. Cl. CPC B41J 2/161; B41J 2/1646; B41J 2/1623; B41J 2/14233

(57) ABSTRACT

A liquid discharge head includes a diaphragm, a first electrode, a piezoelectric body, and a second electrode, which are stacked in this order in a first direction, in which when a region of the piezoelectric body interposed between the first electrode and the second electrode is set as a first region, a region of the piezoelectric body other than the first region is set as a second region, a portion of the piezoelectric body including at least a part of a boundary between the first region and the second region is set as a boundary portion, and a portion of the piezoelectric body that is different from the boundary portion and is located in the first region is set as a non-boundary portion, a dielectric constant of the boundary portion is smaller than a dielectric constant of the non-boundary portion.

The present application is based on, and claims priority from JP Application Serial Number 2020-178709, filed Oct. 26, 2020, the disclosure of which is hereby incorporated by reference herein in its entirety.

### BACKGROUND

### 1. Technical Field

The present disclosure relates to a liquid discharge head, a liquid discharge device, and an actuator.

### 2. Related Art

A liquid discharge device such as a piezo-type ink jet printer includes an actuator using a piezoelectric body. For example, the actuator unit described in JP-A-2016-58467 includes a diaphragm, a lower electrode layer, a piezoelectric layer, and an upper electrode layer, which are stacked in this order.

The actuator unit described in JP-A-2016-58467 includes a portion in which a piezoelectric layer is sandwiched between a lower electrode layer and an upper electrode layer, and a portion in which the piezoelectric layer is not sandwiched between the lower electrode layer and the upper electrode layer. At the boundary between these portions, one portion is deformed according to the electric field between the lower electrode layer and the upper electrode layer, whereas the other portion is hardly deformed by the electric field, and therefore stress is concentrated. In the related art, since the characteristics of the piezoelectric body are constant over the entire region, there is a problem that cracks are likely to occur in the piezoelectric layer due to the stress when trying to improve the characteristics of the piezoelectric body.

### SUMMARY

According to an aspect of the present disclosure, there is provided a liquid discharge head including a diaphragm, a first electrode, a piezoelectric body, and a second electrode which are stacked in this order in a first direction, in which when a region of the piezoelectric body interposed between the first electrode and the second electrode is set as a first region, a region of the piezoelectric body other than the first region is set as a second region, a portion of the piezoelectric body including at least a part of a boundary between the first region and the second region is set as a boundary portion, and a portion of the piezoelectric body that is different from the boundary portion and is located in the first region is set as a non-boundary portion, a dielectric constant of the boundary portion is smaller than a dielectric constant of the non-boundary portion.

According to another aspect of the present disclosure, there is provided a liquid discharge head including a diaphragm, a first electrode, a piezoelectric body, and a second electrode which are stacked in this order in a first direction, in which the piezoelectric body contains lead, and when a region of the piezoelectric body interposed between the first electrode and the second electrode is set as a first region, a region of the piezoelectric body other than the first region is set as a second region, a portion of the piezoelectric body including at least a part of a boundary between the first region and the second region is set as a boundary portion, and a portion of the piezoelectric body that is different from the boundary portion and is located in the first region is set as a non-boundary portion, a lead content of the boundary portion is larger than a lead content of the non-boundary portion.

According to still another aspect of the present disclosure, there is provided a liquid discharge device including the liquid discharge head of the above-described embodiment, and a controller that controls a liquid discharge operation by the liquid discharge head.

According to still another aspect of the present disclosure, there is provided an actuator including a diaphragm, a first electrode, a piezoelectric body, and a second electrode which are stacked in this order in a first direction, in which when a region of the piezoelectric body interposed between the first electrode and the second electrode is set as a first region, a region of the piezoelectric body other than the first region is set as a second region, a portion of the piezoelectric body including at least a part of a boundary between the first region and the second region is set as a boundary portion, and a portion of the piezoelectric body that is different from a boundary portion and is located in the first region is set as the non-boundary portion, a dielectric constant of the boundary portion is smaller than a dielectric constant of the non-boundary portion.

According to still another aspect of the present disclosure, there is provided an actuator including a diaphragm, a first electrode, a piezoelectric body, and a second electrode which are stacked in this order in a first direction, in which the piezoelectric body contains lead, and when a region of the piezoelectric body interposed between the first electrode and the second electrode is set as a first region, a region of the piezoelectric body other than the first region is set as a second region, a portion of the piezoelectric body including at least a part of a boundary between the first region and the second region is set as a boundary portion, and a portion of the piezoelectric body that is different from the boundary portion and is located in the first region is set as a non-boundary portion, a lead content of the boundary portion is larger than a lead content of the non-boundary portion.

### BRIEF DESCRIPTION OF THE DRAWINGS

FIG. 1 is a configuration view schematically illustrating a liquid discharge device according to a first embodiment.

FIG. 2 is an exploded perspective view of a liquid discharge head according to the first embodiment.

FIG. 3 is a cross-sectional view taken along the line III-III in FIG. 2.

FIG. 4 is a plan view illustrating an actuator according to the first embodiment.

FIG. 5 is a cross-sectional view taken along the line V-V in FIG. 4.

FIG. 6 is a cross-sectional view taken along the line VI-VI in FIG. 4.

FIG. 7 is a cross-sectional view taken along the line VII-VII in FIG. 4.

FIG. 8 is a cross-sectional view taken along the line VIII-VIII in FIG. 4.

FIG. 9 is a view illustrating a relationship between an electric field and a strain amount of a boundary portion and a non-boundary portion.

FIG. 10 is a cross-sectional view of an actuator according to a second embodiment.

FIG. 11 is a cross-sectional view of an actuator according to a third embodiment.

FIG. 12 is a cross-sectional view of an actuator according to a fourth embodiment.

FIG. 13 is a cross-sectional view of an actuator according to a fifth embodiment.

FIG. 14 is a cross-sectional view of an actuator according to a sixth embodiment.

FIG. 15 is a cross-sectional view of an actuator according to a seventh embodiment.

FIG. 16 is a cross-sectional view of an actuator according to an eighth embodiment cut at a non-boundary portion of a piezoelectric body.

FIG. 17 is a cross-sectional view of the actuator according to the eighth embodiment cut at a boundary portion of a piezoelectric body.

### DESCRIPTION OF EXEMPLARY EMBODIMENTS

Hereinafter, preferred embodiments according to the present disclosure will be described with reference to the accompanying drawings. In the drawings, the dimensions or scales of each portion are appropriately different from the actual dimensions or scales, and some portions are schematically illustrated for easy understanding. The scope of the present disclosure is not limited to these embodiments unless otherwise particularly stated to limit the present disclosure in the following description.

The following description will be performed by using an X axis, a Y axis, and a Z axis that intersect each other as appropriate. One direction along the X axis is referred to as an X1 direction, and a direction opposite to the X1 direction is referred to as an X2 direction. Similarly, directions opposite to each other along the Y axis are referred to as a Y1 direction and a Y2 direction. Directions opposite to each other along the Z axis are referred to as a Z1 direction and a Z2 direction. The Z1 direction is an example of a “first direction”. The Z2 direction is an example of a “second direction”. Further, viewing in the direction along the Z axis is called “plan view”.

Typically, the Z axis is a vertical axis, and the Z2 direction corresponds to a downward direction in a vertical direction. The Z axis may not be a vertical axis. Although the X axis, the Y axis, and the Z axis are typically orthogonal to each other, the present disclosure is not limited thereto, and the axes may intersect at an angle within, for example, a range of 80° or more and 100° or less.

### 1. FIRST EMBODIMENT

### 1-1. Overall Configuration of Liquid Discharge Device

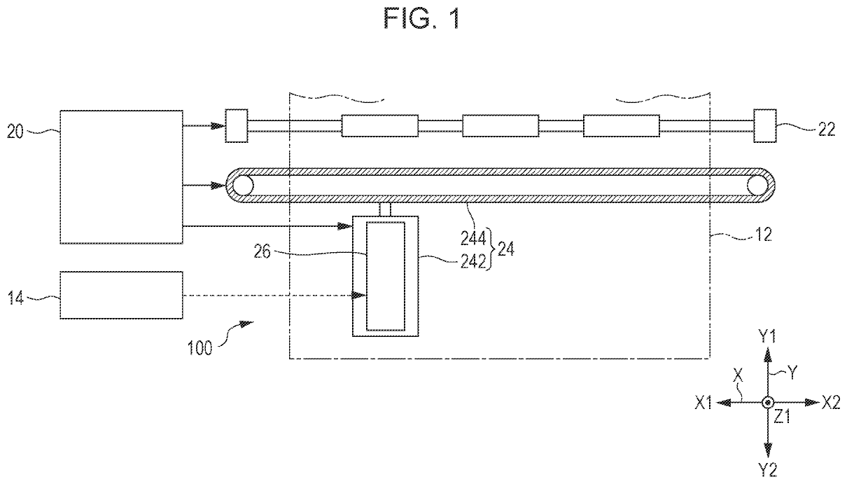

FIG. 1 is a configuration view schematically illustrating a liquid discharge device 100 according to a first embodiment. The liquid discharge device 100 is an ink jet printing device that discharges ink, which is an example of a liquid, as droplets onto a medium 12. The medium 12 is typically printing paper. The medium 12 is not limited to printing paper, and may be a printing target of any material such as a resin film or cloth.

As illustrated in FIG. 1, the liquid discharge device 100 is equipped with a liquid container 14 for storing ink. Specific embodiments of the liquid container 14 include, for example, a cartridge that can be attached to and detached from the liquid discharge device 100, a bag-shaped ink pack made of a flexible film, and an ink tank that can be refilled with ink. The type of ink stored in the liquid container 14 is arbitrary.

The liquid discharge device 100 includes a control unit 20, a transport mechanism 22, a moving mechanism 24, and a liquid discharge head 26. The control unit 20 includes, for example, a processing circuit such as a central processing unit (CPU) or a field programmable gate array (FPGA) and a storage circuit such as a semiconductor memory, and controls the operation of each element of the liquid discharge device 100. Here, the control unit 20 is an example of a “controller” and controls the ink discharge operation by the liquid discharge head 26.

The transport mechanism 22 transports the medium 12 in the Y2 direction under the control of the control unit 20. The moving mechanism 24 causes the liquid discharge head 26 to reciprocate in the X1 direction and the X2 direction under the control of the control unit 20. In the example illustrated in FIG. 1, the moving mechanism 24 includes a substantially box-shaped transport body 242 called a carriage for accommodating the liquid discharge head 26, and a transport belt 244 to which the transport body 242 is fixed. The number of liquid discharge heads 26 mounted on the transport body 242 is not limited to one, and may be a plurality. Further, in addition to the liquid discharge head 26, the above-mentioned liquid container 14 may be mounted on the transport body 242.

Under the control of the control unit 20, the liquid discharge head 26 discharges the ink supplied from the liquid container 14 from each of a plurality of nozzles toward the medium 12 in the Z2 direction. When the discharge is performed in parallel with the transport of the medium 12 by the transport mechanism 22 and the reciprocating movement of the liquid discharge head 26 by the moving mechanism 24, an image is formed with ink on the surface of the medium 12.

As described above, the liquid discharge device 100 includes the liquid discharge head 26 and the control unit 20 which is an example of a “controller” that controls the ink discharge operation by the liquid discharge head 26.

### 1-2. Overall Configuration of Liquid Discharge Head

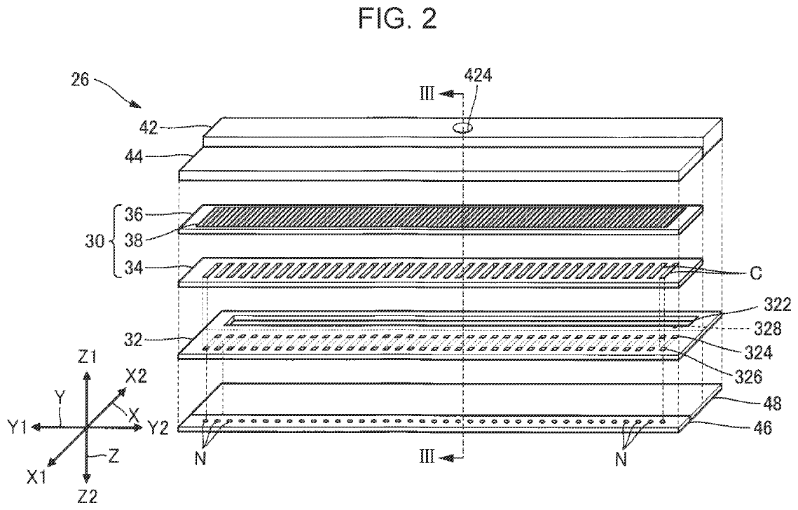

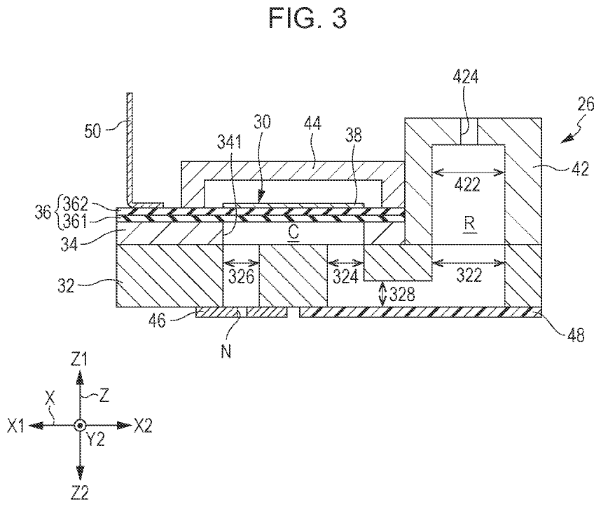

FIG. 2 is an exploded perspective view of the liquid discharge head 26 according to the first embodiment. FIG. 3 is a cross-sectional view taken along the line III-III of FIG. 2. As illustrated in FIGS. 2 and 3, the liquid discharge head 26 includes a channel substrate 32, a pressure chamber substrate 34, a diaphragm 36, a plurality of piezoelectric elements 38, a housing portion 42, a sealing body 44, and a nozzle plate 46, a vibration absorber 48, and a wiring substrate 50. The actuator 30 includes a pressure chamber substrate 34, a diaphragm 36, and the plurality of piezoelectric elements 38.

Here, the pressure chamber substrate 34, the diaphragm 36, the plurality of piezoelectric elements 38, the housing portion 42, and the sealing body 44 are installed in a region located in the Z1 direction with respect to the channel substrate 32. On the other hand, the nozzle plate 46 and the vibration absorber 48 are installed in the region located in the Z2 direction with respect to the channel substrate 32. Each element of the liquid discharge head 26 is generally a plate-shaped member elongated in the Y direction, and is joined to each other by, for example, an adhesive.

As illustrated in FIG. 2, the nozzle plate 46 is a plate-shaped member provided with a plurality of nozzles N arrayed in a direction along the Y axis. Each nozzle N is a through hole through which ink passes. For example, the nozzle plate 46 is manufactured by processing a silicon single crystal substrate by a semiconductor manufacturing technology using a processing technique such as dry etching or wet etching. However, other known methods and materials may be appropriately used for manufacturing the nozzle plate 46.

The channel substrate 32 is a plate-shaped member for forming a channel for ink.

As illustrated in FIGS. 2 and 3, the channel substrate 32 is provided with an opening 322, a plurality of supply channels 324, a plurality of communication channels 326, and a relay channel 328. The opening 322 is a long through hole extending in the direction along the Y axis in a plan view in the direction along the Z axis so as to be continuous over the plurality of nozzles N. On the other hand, each of the supply channel 324 and the communication channel 326 is a through hole individually provided for each nozzle N. As illustrated in FIG. 3, the relay channel 328 is provided on a surface of the channel substrate 32 facing the Z2 direction. The relay channel 328 is provided over the plurality of supply channels 324, and is a channel that allows the opening 322 and the plurality of supply channels 324 to communicate with each other. The channel substrate 32 is manufactured by processing a silicon single crystal substrate by, for example, a semiconductor manufacturing technique, similarly to the nozzle plate 46 described above. However, other known methods and materials may be appropriately used for manufacturing the channel substrate 32.

The pressure chamber substrate 34 is a plate-shaped member in which a plurality of pressure chambers C corresponding to the plurality of nozzles N are formed. The pressure chamber C is located between the channel substrate 32 and the diaphragm 36, and is a space called a cavity for applying pressure to the ink filled in the pressure chamber C. The plurality of pressure chambers C are arrayed in the direction along the Y axis. Each pressure chamber C includes holes 341 that open on both surfaces of the pressure chamber substrate 34, and has a long shape extending in the direction along the X axis. The end of each pressure chamber C in the X2 direction communicates with the corresponding supply channel 324. On the other hand, the end of each pressure chamber C in the X1 direction communicates with the corresponding communication channel 326. The pressure chamber substrate 34 is manufactured by processing a silicon single crystal substrate by, for example, a semiconductor manufacturing technique, similarly to the nozzle plate 46 described above. However, other known methods and materials may be appropriately used for manufacturing of the pressure chamber substrate 34.

The diaphragm 36 is disposed on a surface of the pressure chamber substrate 34 facing the Z1 direction. The diaphragm 36 is a plate-shaped member that can be elastically deformed. In the example illustrated in FIGS. 2 and 3, the diaphragm 36 includes a first layer 361 and a second layer 362, which are stacked in this order in the Z1 direction. The first layer 361 is, for example, an elastic film made of silicon oxide (SiO₂). The elastic film is formed, for example, by thermally oxidizing one surface of a silicon single crystal substrate. The second layer 362 is, for example, an insulating film made of zirconium oxide (ZrO₂). The insulating film is formed by, for example, forming a zirconium layer by a sputtering method and thermally oxidizing the layer.

The first layer 361 is not limited to silicon oxide, and may be made of other elastic material such as silicon alone. The constituent material of the second layer 362 is not limited to zirconium oxide, and may be another insulating material such as silicon nitride. Further, another layer such as a metal oxide may be interposed between the first layer 361 and the second layer 362. Further, a part or all of the diaphragm 36 may be integrally made of the same material as the pressure chamber substrate 34. Further, the diaphragm 36 may include a layer of a single material.

The plurality of piezoelectric elements 38 corresponding to different nozzles N or pressure chambers C are disposed on a surface of the diaphragm 36 facing the Z1 direction. Each piezoelectric element 38 is a passive element that is deformed by the supply of a drive signal, and has a long shape extending in a direction along the X axis. The plurality of piezoelectric elements 38 are arrayed in a direction along the Y axis so as to correspond to the plurality of pressure chambers C. When the diaphragm 36 vibrates in conjunction with the deformation of the piezoelectric element 38, the pressure in the pressure chamber C fluctuates, and ink is discharged from the nozzle N. The details of the piezoelectric element 38 will be described in 1-3.

The housing portion 42 is a case for storing ink supplied to the plurality of pressure chambers C, and is joined to a surface of the channel substrate 32 facing the Z1 direction with an adhesive or the like. The housing portion 42 is made of, for example, a resin material and is manufactured by injection molding. The housing portion 42 is provided with an accommodating portion 422 and an introduction port 424. The accommodating portion 422 is a concave portion having an outer shape corresponding to the opening 322 of the channel substrate 32. The introduction port 424 is a through hole communicating with the accommodating portion 422. The space provided by the opening 322 and the accommodating portion 422 functions as a liquid storage chamber R which is a reservoir for storing ink. Ink from the liquid container 14 is supplied to the liquid storage chamber R via the introduction port 424.

The vibration absorber 48 is an element for absorbing the pressure fluctuation in the liquid storage chamber R. The vibration absorber 48 is, for example, a compliance substrate which is a flexible sheet member that can be elastically deformed. Here, the vibration absorber 48 is disposed on the surface of the channel substrate 32 facing the Z2 direction so that the bottom surface of the liquid storage chamber R is formed by closing the opening 322 of the channel substrate 32, the relay channel 328, and the plurality of supply channels 324.

The sealing body 44 is a structure that protects the plurality of piezoelectric elements 38 and reinforces the mechanical strength of the pressure chamber substrate 34 and the diaphragm 36. The sealing body 44 is joined to the surface of the diaphragm 36 with, for example, an adhesive. The sealing body 44 is provided with a concave portion for accommodating the plurality of piezoelectric elements 38.

The wiring substrate 50 is joined to the surface of the pressure chamber substrate 34 or the diaphragm 36 facing the Z1 direction. The wiring substrate 50 is a mounting component on which a plurality of wirings for electrically couple the control unit 20 and the liquid discharge head 26 are formed. The wiring substrate 50 is, for example, a flexible wiring substrate such as a flexible printed circuit (FPC) or a flexible flat cable (FFC).

A drive signal for driving the piezoelectric element 38 is supplied to the wiring substrate 50. The drive signal is supplied to each piezoelectric element 38 via the wiring substrate 50.

### 1-3. Details of Actuator

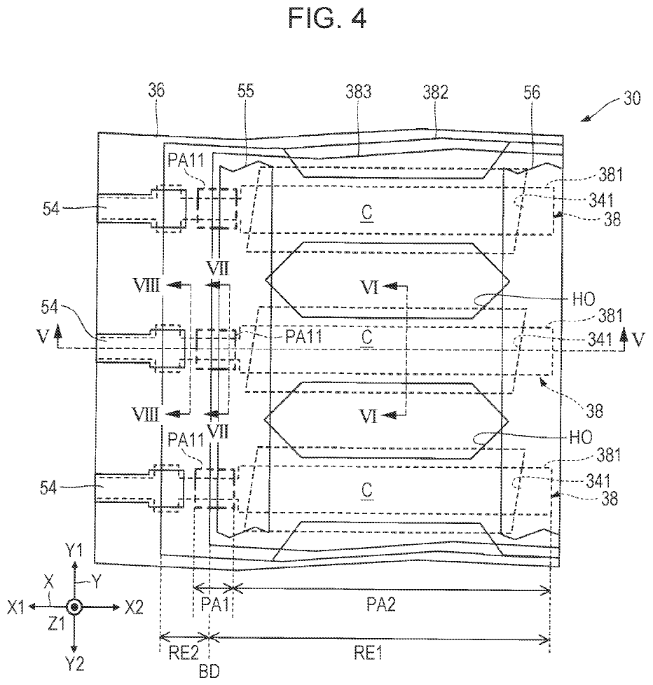

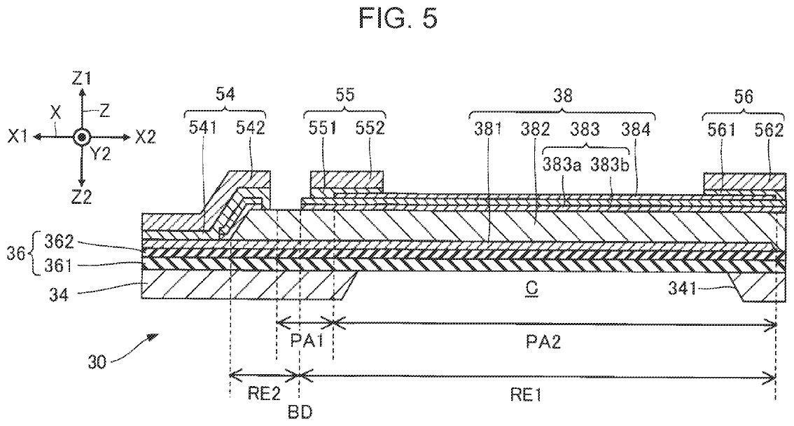

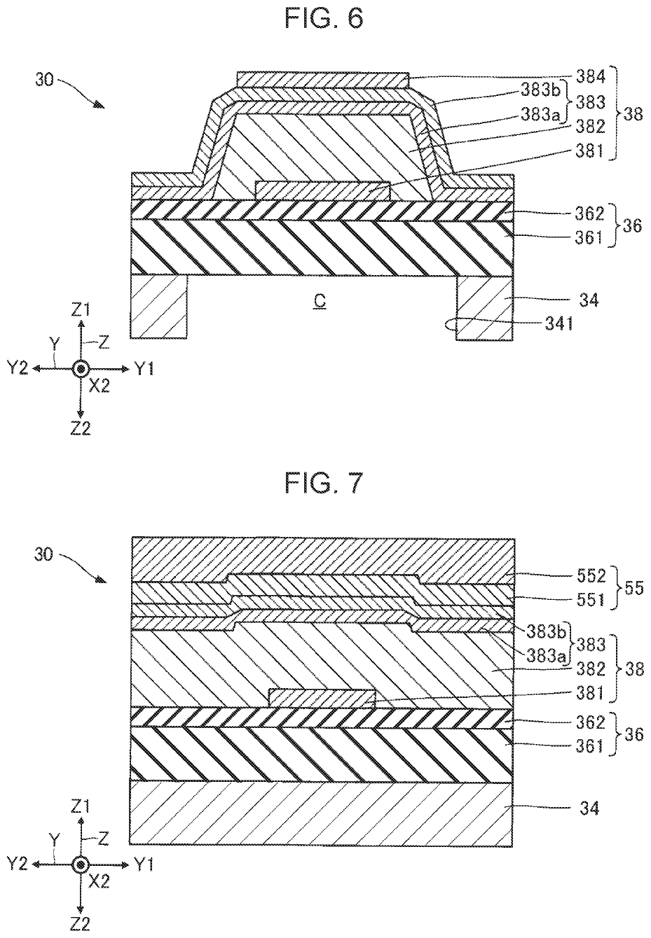

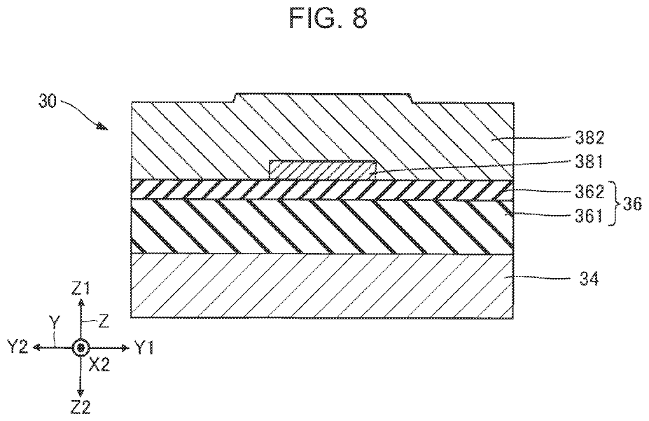

FIG. 4 is a plan view illustrating the actuator 30 according to the first embodiment. FIG. 5 is a cross-sectional view taken along the line V-V in FIG. 4. FIG. 6 is a cross-sectional view taken along the line VI-VI in FIG. 4. FIG. 7 is a cross-sectional view taken along the line VII-VII in FIG. 4. FIG. 8 is a cross-sectional view taken along the line VIII-VIII in FIG. 4. In these views, the configuration of the actuator 30 is illustrated in more detail than in FIGS. 2 and 3 described above.

As illustrated in FIG. 5, the actuator 30 includes a wiring layer 54, a weight layer 55, and a weight layer 56 in addition to the pressure chamber substrate 34, the diaphragm 36, and the plurality of piezoelectric elements 38. Here, in the actuator 30, as described above, the pressure chamber substrate 34, the diaphragm 36, and the plurality of piezoelectric elements 38 are stacked in this order in the Z1 direction, the wiring layer 54, the weight layer 55, and the weight layer 56 are layers located most in the Z1 direction, which are obtained by the same film formation step.

As illustrated in FIGS. 4 and 5, the pressure chamber substrate 34 is provided with the holes 341 forming the pressure chamber C. In FIG. 4, the plan view shape of the hole 341 is illustrated by a broken line. The pressure chamber substrate 34 is formed, for example, by anisotropically etching a silicon single crystal substrate. For example, an aqueous potassium hydroxide solution (KOH) or the like is used as the etching solution for the anisotropic etching. Further, in the anisotropic etching, the first layer 361 of the diaphragm 36 is used as an etching stop layer.

In the example illustrated in FIG. 4, the plan view shape of the hole 341 is a parallelogram. Such a plan-view-shaped hole 341 is formed, for example, by anisotropically etching a silicon single crystal substrate having a plane orientation (110). The plan view shape of the hole 341 is not limited to the example illustrated in FIG. 4, and is arbitrary.

As illustrated in FIG. 4, the piezoelectric element 38 overlaps the pressure chamber C in a plan view. As illustrated in FIG. 5, the piezoelectric element 38 includes a first electrode 381, a piezoelectric body 382, a second electrode 383, and a lead absorption layer 384, which are stacked in this order in the Z1 direction.

Other layers such as a layer for enhancing adhesion may be appropriately interposed between the layers of the piezoelectric element 38 or between the piezoelectric element 38 and the diaphragm 36. Further, a seed layer may be provided between the first electrode 381 and the piezoelectric body 382. The seed layer has a function of improving the orientation of the piezoelectric body 382 when forming the piezoelectric body 382. The seed layer is made of, for example, titanium (Ti) or a composite oxide having a perovskite structure such as Pb(Fe, Ti)O₃. When the seed layer is made of titanium, when the piezoelectric body 382 is formed, the island-shaped Ti becomes crystal nuclei to improve the orientation of the piezoelectric body 382. In this case, the seed layer is formed to have a thickness of about 3 nm or more and 20 nm or less by, for example, a known film forming technique such as a sputtering method and a known processing technique using photolithography and etching. Further, when the seed layer is made of the composite oxide, the orientation of the piezoelectric body 382 is improved because the piezoelectric body 382 is affected by the crystal structure of the seed layer when the piezoelectric body 382 is formed. In this case, the seed layer is formed by forming a precursor layer of a composite oxide by, for example, a sol-gel method or a metal organic decomposition (MOD) method, and firing and crystallizing the precursor layer.

The first electrodes 381 are individual electrodes disposed so as to be separated from each other for each piezoelectric element 38. Specifically, a plurality of first electrodes 381 extending in the direction along the X axis are arrayed in the direction along the Y axis at intervals from each other. A drive signal for discharging ink from the nozzle N corresponding to the piezoelectric element 38 is applied to the first electrode 381 of each piezoelectric element 38 via the wiring substrate 50.

Although not illustrated, the first electrode 381 includes, for example, a first layer made of titanium (Ti), a second layer made of platinum (Pt), and a third layer made of iridium (Ir), which are stacked in this order in the Z1 direction. The first electrode 381 is formed by, for example, a known film forming technique such as a sputtering method, and a known processing technique using photolithography, etching, or the like.

Here, the above-mentioned first layer functions as an adhesion layer for improving the adhesion of the first electrode 381 to the diaphragm 36. The thickness of the first layer is not particularly limited, and is, for example, about 3 nm or more and 50 nm or less. The constituent material of the first layer is not limited to titanium, and for example, chromium may be used instead of titanium.

Further, the metals constituting the second layer and the third layer described above are both electrode materials having excellent conductivity, and have similar chemical properties to each other. Therefore, the characteristics of the first electrode 381 as an electrode can be made excellent. The thickness of the second layer is not particularly limited, and is, for example, about 50 nm or more and 200 nm or less. The thickness of the third layer is not particularly limited, and is, for example, about 4 nm or more and 20 nm or less.

The configuration of the first electrode 381 is not limited to the above-mentioned example. For example, either the above-mentioned second layer or the third layer may be omitted, or a layer made of iridium may be further provided between the above-mentioned first layer and the second layer. Further, instead of the second layer and the third layer, or in addition to the second layer and the third layer, a layer made of an electrode material other than iridium and platinum may be used. Examples of the electrode material include metal materials such as aluminum (Al), nickel (Ni), gold (Au), and copper (Cu), and among these materials, one type may be used alone, or two or more types may be used in combination in the form of a stack or an alloy.

The first electrode 381 is pulled out from the piezoelectric body 382 at a position in the X1 direction, and the wiring layer 54 is coupled to the first electrode 381. The wiring layer 54 is a conductive film extending from the piezoelectric element 38 in the X1 direction for each first electrode 381, and functions as a wiring for coupling the first electrode 381 and the wiring substrate 50. In the example illustrated in FIG. 5, the wiring layer 54 includes a layer 541 and a layer 542, which are stacked in this order in the Z1 direction. The layer 541 is a layer for enhancing the adhesion between the wiring layer 54 and the piezoelectric element 38, and is made of, for example, a nickel-chromium alloy. The layer 542 is a layer for increasing the conductivity of the wiring layer 54, and is made of, for example, gold (Au).

The piezoelectric body 382 is disposed between the first electrode 381 and the second electrode 383. The piezoelectric body 382 has a band shape extending in the direction along the Y axis so as to be continuous over the plurality of piezoelectric elements 38. In the example illustrated in FIG. 4, the piezoelectric body 382 is provided with a through hole HO penetrating the piezoelectric body 382 extending in the direction along the X axis in a region corresponding to the gap between the pressure chambers C adjacent to each other in a plan view. The piezoelectric body 382 may be individually provided on the plurality of piezoelectric elements 38.

The piezoelectric body 382 is made of a piezoelectric material having a perovskite-type crystal structure represented by the general composition formula ABO3. In the present embodiment, the piezoelectric material contains lead. Specifically, examples of the piezoelectric material include, lead titanate (PbTIO₃), lead zirconate titanate (Pb(Zr, Ti)O₃), lead zirconium acid (PbZrO₃), lead titanate lantern ((Pb, La), TiO₃), lead zirconate titanate lantern ((Pb, La) (Zr, Ti)O₃), lead zirconium titanate niobate (Pb (Pb) Zr, Ti, Nb)O₃), lead magnesium niobate zirconium titanate (Pb(Zr, Ti)(Mg, Nb)O₃), and the like. Among these materials, lead zirconate titanate is preferably used as a constituent material of the piezoelectric body 382. The piezoelectric body 382 may contain a small amount of other elements such as impurities.

The piezoelectric body 382 is formed by forming a precursor layer of the piezoelectric body by, for example, a liquid phase method such as a sol-gel method or a metal organic decomposition (MOD) method, and firing and crystallizing the precursor layer. Here, the piezoelectric body 382 may include a single layer, but when including a plurality of layers, there is an advantage that the characteristics of the piezoelectric body 382 can be easily improved even if the thickness of the piezoelectric body 382 is increased.

The second electrode 383 is a band-shaped common electrode extending in the direction along the Y axis so as to be continuous over the plurality of piezoelectric elements 38. A predetermined reference voltage is applied to the second electrode 383.

The second electrode 383 includes a first layer 383a and a second layer 383b, which are stacked in this order in the Z1 direction. The thickness of each of the first layer 383a and the second layer 383b is not particularly limited, and is, for example, in the range of 10 nm or more and 100 nm or less. Each of the first layer 383a and the second layer 383b is formed by, for example, a known film forming technique such as a sputtering method, and a known processing technique using photolithography, etching, or the like.

The constituent materials of the first layer 383a and the second layer 383b are different from each other. The constituent materials of the first layer 383a and the second layer 383b are not particularly limited, and examples thereof include metals such as iridium (Ir), titanium (Ti), platinum (Pt), aluminum (Al), nickel (Ni), gold (Au), copper (Cu), alloys containing these metals, and conductive oxides. However, it is preferable that each of the constituent materials of the first layer 383a and the second layer 383b does not substantially contain a material having an action of absorbing lead, such as the constituent material of the lead absorption layer 384 described later.

The lead absorption layer 384 is disposed on the second electrode 383. The lead absorption layer 384 is disposed over a range overlapping a non-boundary portion PA2 described later in a plan view, and has an action of absorbing excess lead contained in the piezoelectric body 382. The lead absorption layer 384 is made of, for example, titanium. The lead absorption layer 384 is formed by, for example, a known film forming technique such as a sputtering method, and a known processing technique using photolithography, etching, or the like. The thickness of the lead absorption layer 384 is not particularly limited, and is, for example, in the range of 10 nm or more and 100 nm or less. The lead absorption layer 384 may contain a material such as a metal other than titanium as long as it can absorb lead, or may be composed of only a material other than titanium.

When made of titanium, for example, the lead absorption layer 384 absorbs excess lead from the piezoelectric body 382 by a post-annealing treatment after an annealing treatment for crystallizing the precursor layer of the piezoelectric body 382. From the viewpoint of preferably performing the absorption, when the treatment temperature for crystallizing the precursor layer of the piezoelectric body 382 is T1[°] and the treatment temperature for the post-annealing treatment is T2[°], it is preferable to satisfy the relationship of (T1−10)<T2<(T1+50). Here, the lead absorption layer 384 is formed, for example, after the second electrode 383 is formed after the annealing treatment for crystallizing the precursor layer of the piezoelectric body 382.

The weight layer 55 and the weight layer 56 are disposed on the lead absorption layer 384. In the example illustrated in FIG. 5, a part of the lead absorption layer 384 is also disposed on a part on the second electrode 383. The weight layer 55 and the weight layer 56 are weights for suppressing unnecessary vibration of the diaphragm 36. Specifically, the weight layer 55 is a band-shaped conductive film extending along the Y axis along the edge of the second electrode 383 in the X1 direction. In the example illustrated in FIG. 5, the weight layer 55 includes a layer 551 obtained by the same film formation step as the layer 541 and a layer 552 obtained by the same film formation step as the layer 542, which are stacked in this order in the Z1 direction. The weight layer 56 is a band-shaped conductive film extending along the Y axis along the edge of the second electrode 383 in the X2 direction. In the example illustrated in FIG. 5, the weight layer 55 includes a layer 551 obtained by the same film formation step as the layer 541 and a layer 552 obtained by the same film formation step as the layer 542, which are stacked in this order in the Z1 direction.

In the piezoelectric element 38 having the above basic configuration, the piezoelectric body 382 includes a first region RE1 interposed between the first electrode 381 and the second electrode 383, and a second region RE2 other than the first region RE1. In other words, the first region RE1 is a region in which the piezoelectric body 382 is sandwiched between the first electrode 381 and the second electrode 383 in the direction along the Z axis. Further, the second region RE2 is a region in which the piezoelectric body 382 is not sandwiched between the first electrode 381 and the second electrode 383 in the direction along the Z axis.

Here, the length of each of the first electrode 381, the piezoelectric body 382, and the second electrode 383 along the X axis is longer than the length of the pressure chamber C along the X axis, and the ends of the first electrode 381, the piezoelectric body 382, and the second electrode 383 in the X1 and X2 directions, respectively, are located outside the pressure chamber C in a plan view.

In particular, since the end of the first electrode 381 in the X1 direction needs to be coupled to the wiring substrate 50 described above, the end of the first electrode 381 is located in the X1 direction with respect to the end of the piezoelectric body 382 in the X1 direction. Further, since it is necessary to secure the insulating property between the first electrode 381 and the second electrode 383, the end of the piezoelectric body 382 in the X1 direction is located in the X1 direction with respect to the end of the second electrode 383 in the X1 direction. Further, since it is necessary to apply an electric field to the piezoelectric body 382 over the entire region of the pressure chamber C in the direction along the X axis, the end of the second electrode 383 in the X1 direction is located in the X1 direction with respect to the end of the pressure chamber C in the X1 direction. From the positional relationship of the ends in the X1 direction, a boundary BD between the first region RE1 and the second region RE2 is located at a portion of the piezoelectric body 382 that is constrained by deformation due to joining with the pressure chamber substrate 34 via the diaphragm 36 as illustrated in FIGS. 7 and 8.

In the first region RE1, as illustrated in FIGS. 6 and 7, since both the first electrode 381 and the second electrode 383 exist, an electric field between the first electrode 381 and the second electrode 383 is applied to the piezoelectric body 382. On the other hand, in the second region RE2, as illustrated in FIG. 8, since the second electrode 383 does not exist, the electric field is not applied to the piezoelectric body 382. Therefore, at the boundary BD between the first region RE1 and the second region RE2, if the piezoelectric body 382 is greatly deformed by the electric field, cracks are likely to occur due to stress concentration.

Therefore, in the actuator 30, the piezoelectric characteristics of a boundary portion PA1 are lower than the piezoelectric characteristics of the non-boundary portion PA2 so that the deformation of the boundary portion PA1 which is a portion of the piezoelectric body 382 near the boundary BD due to the electric field is smaller than that of the non-boundary portion PA2 which is another portion.

Here, the boundary portion PA1 may be a portion of the piezoelectric body 382 including at least a part of the boundary BD, but in the present embodiment, includes a plurality of portions PA11s divided for each first electrode 381 as illustrated by the alternate long and two short dashes line in FIG. 4. Each of the plurality of portions PA11s does not overlap the pressure chamber C in a plan view. The boundary portion PA1 may include one portion of the piezoelectric body 382 common to the first electrode 381 so as to include the plurality of portions PA11. However, it is preferable that the boundary portion PA1 does not overlap the pressure chamber C in a plan view.

On the other hand, the non-boundary portion PA2 may be a portion of the piezoelectric body 382 that is different from the boundary portion PA1 and is located in the first region RE1, but in the example illustrated in FIG. 4, is a portion of the piezoelectric body 382 in a range over the entire region of the pressure chamber C in the longitudinal direction.

In the present embodiment, the lead absorption layer 384 forms the boundary portion PA1 having lower piezoelectric characteristics than the non-boundary portion PA2. That is, the lead absorption layer 384 overlaps the non-boundary portion PA2 and does not overlap the boundary portion PA1 when viewed in the Z1 direction. Therefore, the lead content of the boundary portion PA1 is larger than the lead content of the non-boundary portion PA2. Further, the dielectric constant of the boundary portion PA1 is smaller than the dielectric constant of the non-boundary portion PA2. As a result, the piezoelectric characteristics of the boundary portion PA1 are lower than the piezoelectric characteristics of the non-boundary portion PA2.

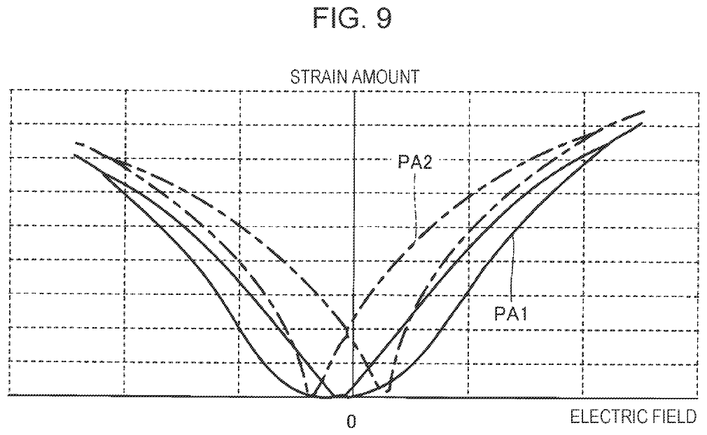

FIG. 9 is a view illustrating the relationship between the electric field and the strain amount of the boundary portion PA1 and the non-boundary portion PA2. Under the same electric field, the strain amount of the boundary portion PA1 illustrated by the solid line in FIG. 9 is smaller than the strain amount of the non-boundary portion PA2 illustrated by the alternate long and short dash line in FIG. 9.

As described above, the liquid discharge head 26 includes the actuator 30. In the actuator 30, the diaphragm 36, the first electrode 381, the piezoelectric body 382, and the second electrode 383 are stacked in this order in the Z1 direction, which is an example of the “first direction”.

In particular, the dielectric constant of the boundary portion PA1 of the piezoelectric body 382 is smaller than the dielectric constant of the non-boundary portion PA2 of the piezoelectric body 382. As described above, the boundary portion PA1 is a portion of the piezoelectric body 382 including at least a part of the boundary BD between the first region RE1 and the second region RE2 of the piezoelectric body 382. The first region RE1 is a region of the piezoelectric body 382 interposed between the first electrode 381 and the second electrode 383. The second region RE2 is a region of the piezoelectric body 382 other than the first region RE1. The non-boundary portion PA2 is a portion of the piezoelectric body 382 that is different from the boundary portion PA1 and is located in the first region RE1.

In the above actuator 30 or the liquid discharge head 26, since the dielectric constant of the boundary portion PA1 is smaller than the dielectric constant of the non-boundary portion PA2, the piezoelectric characteristics of the boundary portion PA1 may be lower than the piezoelectric characteristics of the non-boundary portion PA2. Therefore, even if an electric field is applied to the boundary portion PA1, the deformation of the boundary portion PA1 is reduced, and therefore the stress concentration at the boundary BD between the first region RE1 and the second region RE2 of the piezoelectric body 382 can be reduced. As a result, even if the displacement of the piezoelectric body 382 is increased, cracks at the boundary BD of the piezoelectric body 382 can be reduced.

As described above, the piezoelectric body 382 of the present embodiment contains lead. The lead content of the boundary portion PA1 is larger than the lead content of the non-boundary portion PA2. Therefore, the dielectric constant of the boundary portion PA1 can be made smaller than the dielectric constant of the non-boundary portion PA2.

The actuator 30 of the present embodiment includes the lead absorption layer 384 as described above. The lead absorption layer 384 is disposed in the Z1 direction with respect to the piezoelectric body 382 and has an action of absorbing lead. Further, the lead absorption layer 384 is configured to overlap the non-boundary portion PA2 and not to overlap the boundary portion PA1 when viewed in the Z1 direction. With this configuration, the lead content of the boundary portion PA1 can be made larger than the lead content of the non-boundary portion PA2.

The lead absorption layer 384 may include a portion that overlaps the boundary portion PA1 when viewed in the Z1 direction. In this case, the thickness of the portion is smaller than the thickness of the portion of the lead absorption layer 384 that overlaps the non-boundary portion PA2 when viewed in the Z1 direction. That is, in this case, the lead absorption layer 384 has a configuration in which the thickness of the portion overlapping the non-boundary portion PA2 in the Z1 direction is large than the thickness of the portion overlapping the boundary portion PA1 in the Z1 direction. With this configuration, the lead content of the boundary portion PA1 can be made larger than the lead content of the non-boundary portion PA2.

In the present embodiment, as described above, the piezoelectric body 382, the second electrode 383, and the lead absorption layer 384 are stacked in this order in the Z1 direction. That is, the second electrode 383 is disposed between the piezoelectric body 382 and the lead absorption layer 384. Therefore, as compared with the configuration in which the lead absorption layer 384 is interposed between the piezoelectric body 382 and the second electrode 383, the inverse piezoelectric effect of the piezoelectric body 382 can be efficiently generated by the electric field between the first electrode 381 and the second electrode 383.

Here, the lead absorption layer 384 preferably contains titanium. When the lead absorption layer 384 contains titanium and the piezoelectric body 382 is made of a piezoelectric material such as PZT containing titanium as a constituent element, lead from the piezoelectric body 382 can be efficiently absorbed by the lead absorption layer 384.

Further, the actuator 30 includes the pressure chamber substrate 34 as described above. The pressure chamber substrate 34 is disposed in the Z2 direction, which is an example of the “second direction opposite to the first direction”, with respect to the diaphragm 36, and partitions the plurality of pressure chambers C to be arrayed. Then, the boundary portion PA1 and the non-boundary portion PA2 are adjacent to each other in a direction intersecting with respect to the array direction of the plurality of pressure chambers C. That is, the boundary portion PA1 and the non-boundary portion PA2 are adjacent to each other in the X1 direction or the X2 direction, which is the longitudinal direction of each pressure chamber C.

In the present embodiment, as described above, the first electrode 381 is individually provided for the plurality of pressure chambers C. On the other hand, the second electrode 383 is commonly provided for the plurality of pressure chambers C. Here, in each of the X1 direction and the X2 direction, the respective ends of the first electrode 381 and the second electrode 383 are located outside the pressure chamber C. Further, the end of the first electrode 381 in the X1 direction is located in the X1 direction with respect to the end of the second electrode 383 in the X1 direction. Therefore, the boundary BD overlaps the portion of the pressure chamber substrate 34 without the pressure chamber C in a plan view. In other words, the boundary BD does not overlap the pressure chamber C in a plan view. Therefore, the deformation difference between the first region RE1 and the second region RE2 of the piezoelectric body 382 can be reduced as compared with the configuration in which the boundary BD overlaps the pressure chamber C in a plan view. From this point of view, as described above, the boundary portion PA1 does not overlap the pressure chamber C when viewed in the X1 direction.

### 2. SECOND EMBODIMENT

Hereinafter, a second embodiment of the present disclosure will be described. For the elements whose actions and functions are the same as those of the first embodiment in the embodiments illustrated below, the reference numerals used in the description of the first embodiment will be diverted and detailed description of each will be omitted as appropriate.

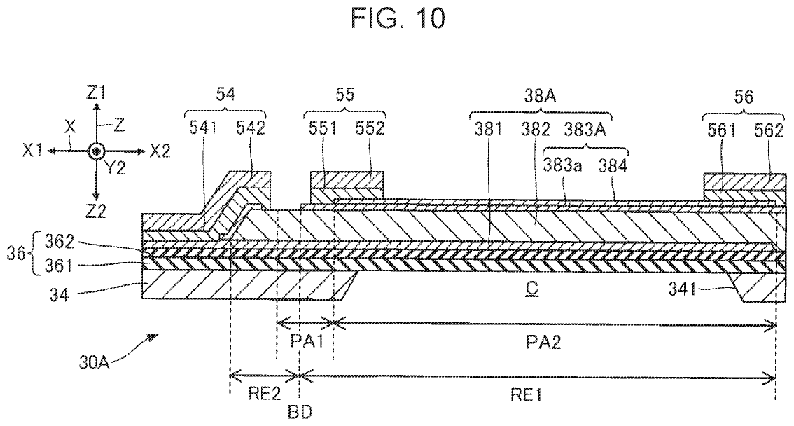

FIG. 10 is a cross-sectional view of an actuator 30A according to the second embodiment. The actuator 30A is the same as the actuator 30 of the first embodiment described above, except that a piezoelectric element 38A is provided instead of the piezoelectric element 38. The piezoelectric element 38A is the same as the piezoelectric element 38 except that the second layer 383b is omitted. Here, the first layer 383a and the lead absorption layer 384 constitute a second electrode 383A.

The cracks in the piezoelectric body 382 can also be reduced by the above-mentioned second embodiment as in the above-mentioned first embodiment.

### 3. THIRD EMBODIMENT

Hereinafter, a third embodiment of the present disclosure will be described. For the elements whose actions and functions are the same as those of the first embodiment in the embodiments illustrated below, the reference numerals used in the description of the first embodiment will be diverted and detailed description of each will be omitted as appropriate.

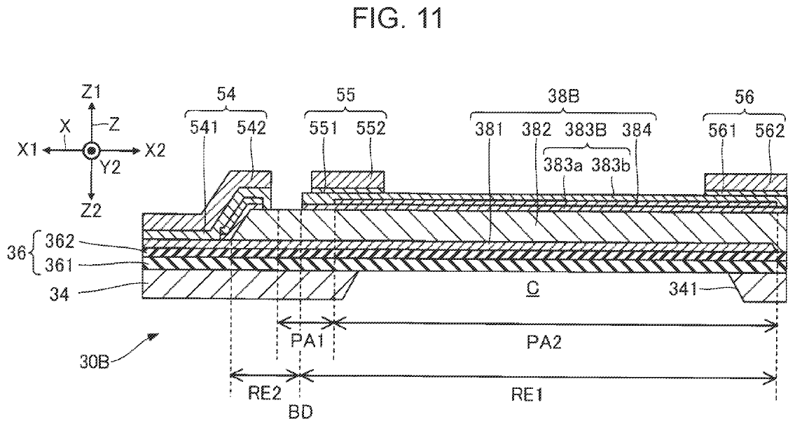

FIG. 11 is a cross-sectional view of an actuator 30B according to the third embodiment. The actuator 30B is the same as the actuator 30 of the first embodiment described above, except that a piezoelectric element 38B is provided instead of the piezoelectric element 38. The piezoelectric element 38B is the same as the piezoelectric element 38 except that the disposition of the lead absorption layer 384 is different. Here, the lead absorption layer 384 is disposed between the first layer 383a and the second layer 383b. In this way, the first layer 383a and the second layer 383b that sandwich the lead absorption layer 384 constitute the second electrode 383B.

The cracks in the piezoelectric body 382 can also be reduced by the above-mentioned third embodiment as in the above-mentioned first embodiment. In the present embodiment, as described above, the second electrode 383B includes the first layer 383a and the second layer 383b, and the first layer 383a and the second layer 383b are stacked in this order in the Z1 direction. The lead absorption layer 384 is disposed between the first layer 383a and the second layer 383b. Therefore, since the first layer 383a is disposed between the piezoelectric body 382 and the lead absorption layer 384, similar to the first embodiment described above, an electric field can be efficiently applied to the piezoelectric body 382 between the first electrode 381 and the second electrode 383B. Further, as compared with the second embodiment in which the second layer 383b is not used, since it is easy to increase the conductivity of the second electrode 383B, an electric field can be efficiently applied to the piezoelectric body 382 between the first electrode 381 and the second electrode 383B also in this respect.

### 4. FOURTH EMBODIMENT

Hereinafter, a fourth embodiment of the present disclosure will be described. For the elements whose actions and functions are the same as those of the first embodiment in the embodiments illustrated below, the reference numerals used in the description of the first embodiment will be diverted and detailed description of each will be omitted as appropriate.

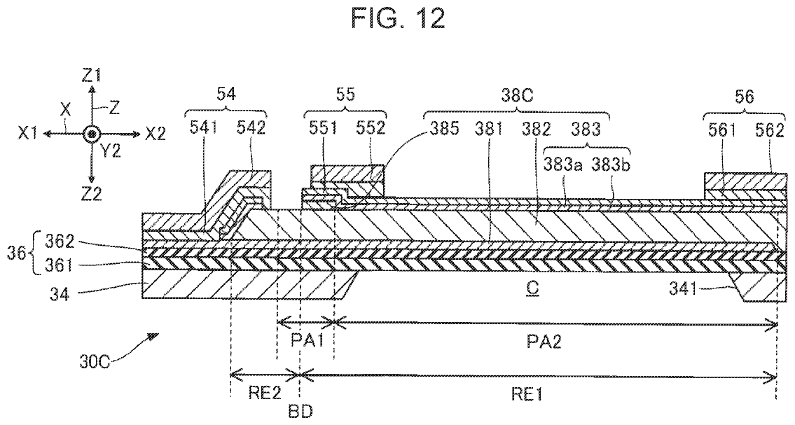

FIG. 12 is a cross-sectional view of an actuator 30C according to the fourth embodiment. The actuator 30C is the same as the actuator 30 of the first embodiment described above, except that a piezoelectric element 38C is provided instead of the piezoelectric element 38. The piezoelectric element 38C is the same as the piezoelectric element 38 except that a lead diffusion suppression layer 385 is provided instead of the lead absorption layer 384.

The lead diffusion suppression layer 385 is disposed between the piezoelectric body 382 and the second electrode 383. The lead diffusion suppression layer 385 is disposed over a range overlapping the boundary portion PA1 in a plan view, and has an effect of suppressing the diffusion of lead from the piezoelectric body 382. Examples of the lead diffusion suppression layer 385 include precious metals such as gold (Au), silver (Ag), and platinum (Pt), and metal oxides such as ZrO₂ and HfO₂. Among these materials, iridium, platinum, ZrO₂, HfO₂ and the like are preferable as the constituent materials of the lead diffusion suppression layer 385 from the viewpoint that the action can be suitably exhibited. the lead diffusion suppression layer 385 is formed by, for example, a known film forming technique such as a sputtering method, and a known processing technique using photolithography, etching, or the like. The thickness of the lead absorption layer 384 is not particularly limited, and is preferably in the range of, for example, 5 nm or more and 100 nm or less.

The cracks in the piezoelectric body 382 can also be reduced by the above-mentioned fourth embodiment as in the above-mentioned first embodiment. As described above, the actuator 30C of the present embodiment includes the lead diffusion suppression layer 385. The lead diffusion suppression layer 385 is disposed in the Z1 direction with respect to the piezoelectric body 382 and has an action of suppressing lead diffusion. The lead diffusion suppression layer 385 is configured to overlap the boundary portion PA1 and not to overlap the non-boundary portion PA2 when viewed in the Z1 direction. With this configuration, the lead content of the boundary portion PA1 can be made larger than the lead content of the non-boundary portion PA2.

Here, the lead diffusion suppression layer 385 preferably contains any one of iridium, platinum, zinc, and hafnium. These metals or the oxides thereof do not easily absorb lead. Therefore, the diffusion of lead from the piezoelectric body 382 can be suitably suppressed.

### 5. FIFTH EMBODIMENT

Hereinafter, a fifth embodiment of the present disclosure will be described. For the elements whose actions and functions are the same as those of the first embodiment in the embodiments illustrated below, the reference numerals used in the description of the first embodiment will be diverted and detailed description of each will be omitted as appropriate.

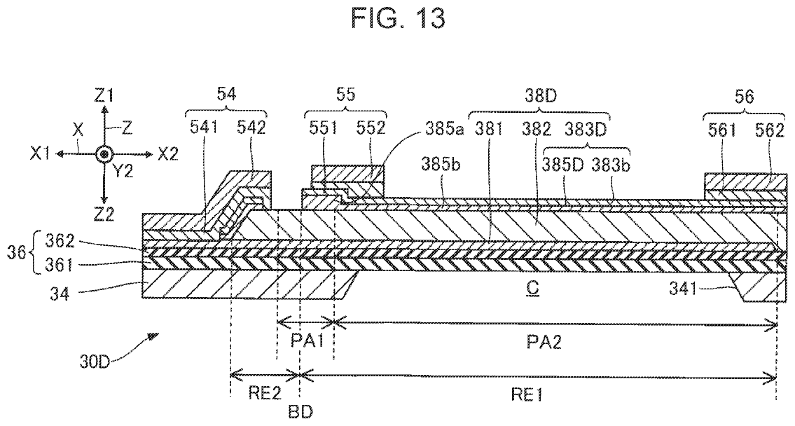

FIG. 13 is a cross-sectional view of an actuator 30D according to the fifth embodiment. The actuator 30D is the same as the actuator 30 of the first embodiment described above, except that a piezoelectric element 38D is provided instead of the piezoelectric element 38. The piezoelectric element 38D is the same as the piezoelectric element 38C of the fourth embodiment except that the first layer 383a and the lead diffusion suppression layer 385 are integrated with the same material. The piezoelectric element 38C includes a lead diffusion suppression layer 385D disposed between the piezoelectric body 382 and the second layer 383b.

The lead diffusion suppression layer 385D has a configuration in which the thickness of the portion 385a overlapping the boundary portion PA1 in the Z1 direction is larger than the thickness of the portion 385b overlapping the non-boundary portion PA2 in the Z1 direction. Also with this configuration, the lead content of the boundary portion PA1 can be made larger than the lead content of the non-boundary portion PA2, as in the fourth embodiment described above.

The cracks in the piezoelectric body 382 can also be reduced by the above-mentioned fifth embodiment as in the above-mentioned first embodiment.

### 6. SIXTH EMBODIMENT

Hereinafter, a sixth embodiment of the present disclosure will be described. For the elements whose actions and functions are the same as those of the first embodiment in the embodiments illustrated below, the reference numerals used in the description of the first embodiment will be diverted and detailed description of each will be omitted as appropriate.

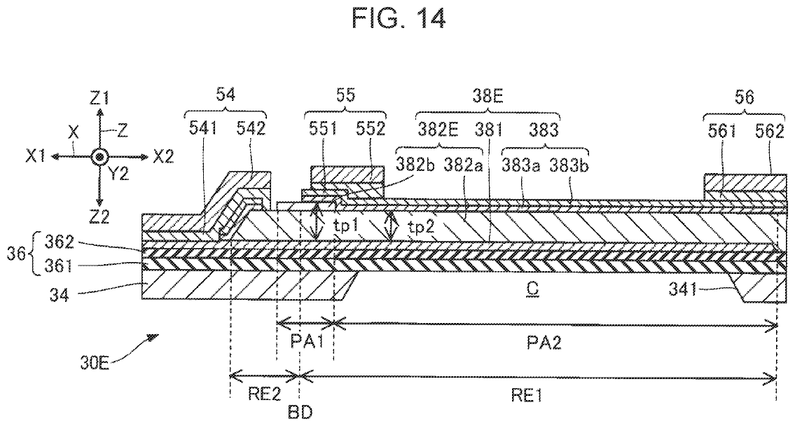

FIG. 14 is a cross-sectional view of the actuator 30E according to the sixth embodiment. The actuator 30E is the same as the actuator 30 of the first embodiment described above, except that a piezoelectric element 38E is provided instead of the piezoelectric element 38. The piezoelectric element 38E is the same as the piezoelectric element 38 except that a piezoelectric body 382E is provided instead of the piezoelectric body 382.

The piezoelectric body 382E is disposed between the first electrode 381 and the second electrode 383. The piezoelectric body 382E includes a layer 382a and a layer 382b, which are stacked in this order in the Z1 direction. The layer 382a is provided over the entire region of the first region RE1 and the second region RE2. On the other hand, the layer 382b is provided only on the boundary portion PA1. Therefore, a thickness tp1 of the boundary portion PA1 is larger than a thickness tp2 of the non-boundary portion PA2.

Each of the layer 382a and the layer 382b is made of the same piezoelectric material as the piezoelectric body 382 of the first embodiment described above. These layers are formed by separate film formation steps. Here, the lead content of the layer 382b is larger than the lead content of the layer 382a. Therefore, the lead content of the boundary portion PA1 can be made larger than the lead content of the non-boundary portion PA2.

The cracks in the piezoelectric body 382E can also be reduced by the above-mentioned sixth embodiment as in the above-mentioned first embodiment. In the present embodiment, the thickness tp1 of the boundary portion PA1 is larger than the thickness tp2 of the non-boundary portion PA2. Therefore, when the piezoelectric body 382E is annealed, the lead content of the boundary portion PA1 can be made larger than the lead content of the non-boundary portion PA2. Further, in the present embodiment, the piezoelectric body 382E includes a stack of layers 382a and 382b. The layer 382a is provided over both the boundary portion PA1 and the non-boundary portion PA2, whereas the layer 382b is provided on the boundary portion PA1 without being provided on the non-boundary portion PA2. Since these layers are formed by separate film formation steps, the lead content of the layer 382b can be made larger than the lead content of the layer 382a. Therefore, the lead content of the boundary portion PA1 can be made larger than the lead content of the non-boundary portion PA2. Further, the layer 382b has an action of suppressing the diffusion of lead from the layer 382a in the same manner as the lead diffusion suppression layer 385 of the fourth embodiment described above. Therefore, there is an advantage that the lead content of the boundary portion PA1 can be easily increased to be larger than the lead content of the non-boundary portion PA2.

In the present embodiment, the piezoelectric body 382E may not contain lead, and for example, the piezoelectric body 382E may be made of a lead-free material such as barium titanate.

### 7. SEVENTH EMBODIMENT

Hereinafter, a seventh embodiment of the present disclosure will be described. For the elements whose actions and functions are the same as those of the first embodiment in the embodiments illustrated below, the reference numerals used in the description of the first embodiment will be diverted and detailed description of each will be omitted as appropriate.

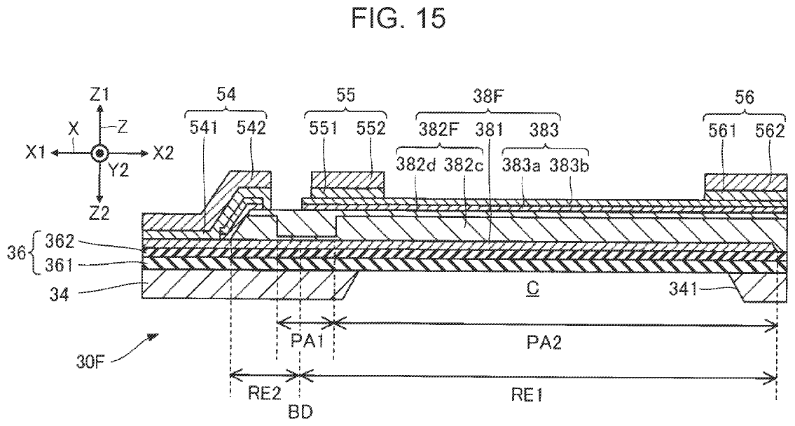

FIG. 15 is a cross-sectional view of an actuator 30F according to the seventh embodiment. The actuator 30F is the same as the actuator 30 of the first embodiment described above, except that a piezoelectric element 38F is provided instead of the piezoelectric element 38. The piezoelectric element 38F is the same as the piezoelectric element 38 except that a piezoelectric body 382F is provided instead of the piezoelectric body 382.

The piezoelectric body 382F is disposed between the first electrode 381 and the second electrode 383. The piezoelectric body 382F includes a layer 382c and a layer 382d, which are stacked in this order in the Z1 direction. The layers 382c and 382d are provided over the entire region of the first region RE1 and the second region RE2, respectively. However, a concave portion is provided on the surface of the layer 382c facing the Z1 direction over a range overlapping the boundary portion PA1 in a plan view. The layer 382d is provided on the layer 382c so as to fill the concave portion. Therefore, in the layer 382d, the thickness of the portion of the layer 382d corresponding to the boundary portion PA1 is larger than the thickness of the portion of the layer 382d corresponding to the non-boundary portion PA2.

Each of the layer 382c and the layer 382d is made of the same piezoelectric material as the piezoelectric body 382 of the first embodiment described above. These layers are formed by separate film formation steps. Here, the lead content of the layer 382d is larger than the lead content of the layer 382c. Therefore, the lead content of the boundary portion PA1 can be made larger than the lead content of the non-boundary portion PA2.

The cracks in the piezoelectric body 382F can also be reduced by the above-mentioned seventh embodiment as in the above-mentioned first embodiment.

### 8. EIGHTH EMBODIMENT

Hereinafter, an eighth embodiment of the present disclosure will be described. For the elements whose actions and functions are the same as those of the first embodiment in the embodiments illustrated below, the reference numerals used in the description of the first embodiment will be diverted and detailed description of each will be omitted as appropriate.

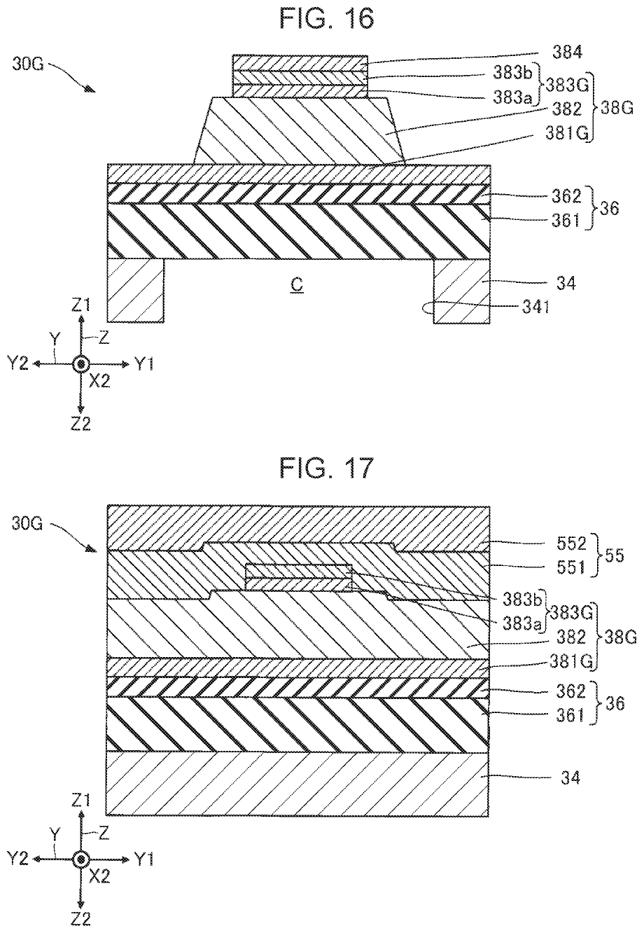

FIG. 16 is a cross-sectional view of the actuator 30G according to the eighth embodiment cut at the non-boundary portion PA2 of the piezoelectric body 382. FIG. 17 is a cross-sectional view of the actuator 30G according to the eighth embodiment cut at the boundary portion PA1 of the piezoelectric body 382. The actuator 30G is the same as the actuator 30 of the first embodiment described above, except that a piezoelectric element 38G is provided instead of the piezoelectric element 38. The piezoelectric element 38G is the same as the piezoelectric element 38 except that a first electrode 381G and a second electrode 383G are provided instead of the first electrode 381 and the second electrode 383.

As illustrated in FIGS. 16 and 17, the first electrode 381G is a band-shaped common electrode extending in the direction along the Y axis so as to be continuous over the plurality of piezoelectric elements 38G. On the other hand, the second electrodes 383G are individual electrodes disposed so as to be separated from each other for each piezoelectric element 38G. Here, as in the first embodiment described above, the lead content of the boundary portion PA1 is larger than the lead content of the non-boundary portion PA2. Further, the dielectric constant of the boundary portion PA1 is smaller than the dielectric constant of the non-boundary portion PA2.

The cracks in the piezoelectric body 382 can also be reduced by the above-mentioned eighth embodiment as in the above-mentioned first embodiment. In the present embodiment, the first electrode 381G is commonly provided for the plurality of pressure chambers C. On the other hand, the second electrode 383G is individually provided for the plurality of pressure chambers C.

### 9. MODIFICATION EXAMPLES

The embodiments in the above examples can be variously modified. Specific modification aspects applicable to each of the above-mentioned embodiments are illustrated below. It should be noted that two or more aspects randomly selected from the following examples can be appropriately merged without contradicting each other.

### 9-1. Modification Example 1

In each of the above-described embodiments, a configuration in which the second region RE2 is located in the X1 direction with respect to the first region RE1 is exemplified, but the configuration is not limited thereto, and the second region RE2 may be located in the X2 direction with respect to the first region RE1. In this case, the boundary portion PA1 is located in the X2 direction with respect to the non-boundary portion PA2.

### 9-2. Modification Example 2

In the above-described embodiment, the configuration in which the actuator is mounted on the liquid discharge head is exemplified, but the device on which the actuator is mounted is not limited to the liquid discharge head, and may be another drive device such as a piezoelectric actuator, for example.

### 9-3. Modification Example 3

In the above-described embodiments, a configuration in which the piezoelectric body is interposed between the individual electrodes and the common electrode is exemplified, but the present disclosure is not limited thereto, and a piezoelectric body may be interposed between the individual electrodes.

### 9-4. Modification Example 4

In each of the above-described embodiments, the serial type liquid discharge device 100 for causing the transport body 242 to reciprocate on which the liquid discharge head 26 is mounted is exemplified, the present disclosure can also be applied to a line-type liquid discharge device in which a plurality of nozzles N are distributed over the entire width of the medium 12.

### 9-5. Modification Example 5

In each of the above-described embodiments, the configuration in which the piezoelectric body contains lead and the lead content of the boundary portion PA1 is larger than the lead content of the non-boundary portion PA2 is exemplified, but the present disclosure is not limited thereto. Even if the lead content does not satisfy this relationship, the dielectric constant of the boundary portion PA1 may be smaller than the dielectric constant of the non-boundary portion PA2.

### 9-6. Modification Example 6

In each of the above-described embodiments, a configuration in which the piezoelectric body contains lead is exemplified, but the present disclosure is not limited thereto, and the piezoelectric body may not contain lead. For example, the piezoelectric body 382E may be made of a lead-free material such as barium titanate. Even in this case, the dielectric constant of the boundary portion PA1 may be smaller than the dielectric constant of the non-boundary portion PA2.

### 9-7. Modification Example 7

The liquid discharge device 100 illustrated in each of the above-described embodiments can be adopted in various devices such as a facsimile machine and a copier, in addition to a device dedicated to printing. The application of the liquid discharge device of the present disclosure is not limited to printing. For example, a liquid discharge device that discharges a solution of a coloring material is used as a manufacturing apparatus that forms a color filter of a liquid crystal display device. A liquid discharge device that discharges a solution of a conductive material is used as a manufacturing apparatus that forms a wiring and an electrode on a wiring substrate.

What is claimed is:

1. A liquid discharge head comprising: a diaphragm, a first electrode, a piezoelectric body, and a second electrode which are stacked in this order in a first direction, wherein
when a region of the piezoelectric body interposed between the first electrode and the second electrode is set as a first region, a region of the piezoelectric body other than the first region is set as a second region, a portion of the piezoelectric body including at least a part of a boundary between the first region and the second region is set as a boundary portion, and a portion of the piezoelectric body that is different from the boundary portion and is located in the first region is set as a non-boundary portion, a dielectric constant of the boundary portion is smaller than a dielectric constant of the non-boundary portion.

2. The liquid discharge head according to claim 1, wherein
the piezoelectric body contains lead, and
a lead content of the boundary portion is larger than a lead content of the non-boundary portion.

3. A liquid discharge head comprising: a diaphragm, a first electrode, a piezoelectric body, and a second electrode which are stacked in this order in a first direction, wherein
the piezoelectric body contains lead, and
when a region of the piezoelectric body interposed between the first electrode and the second electrode is set as a first region, a region of the piezoelectric body other than the first region is set as a second region, a portion of the piezoelectric body including at least a part of a boundary between the first region and the second region is set as a boundary portion, and a portion of the piezoelectric body that is different from the boundary portion and is located in the first region is set as a non-boundary portion, a lead content of the boundary portion is larger than a lead content of the non-boundary portion.

4. The liquid discharge head according to claim 2, further comprising:
a lead absorption layer that is disposed in the first direction with respect to the piezoelectric body and has an action of absorbing lead, wherein
the lead absorption layer is configured to overlap the non-boundary portion and not to overlap the boundary portion when viewed in the first direction, or
a thickness of a portion overlapping the non-boundary portion when viewed in the first direction is configured to be larger than a thickness of a portion overlapping the boundary portion when viewed in the first direction.

5. The liquid discharge head according to claim 4, wherein
the second electrode is disposed between the piezoelectric body and the lead absorption layer.

6. The liquid discharge head according to claim 4, wherein
the second electrode includes a first layer and a second layer,
the first layer and the second layer are stacked in this order in the first direction, and
the lead absorption layer is disposed between the first layer and the second layer.

7. The liquid discharge head according to claim 4, wherein
the lead absorption layer contains titanium.

8. The liquid discharge head according to claim 2, further comprising:
a lead diffusion suppression layer that is disposed in the first direction with respect to the piezoelectric body and has an action of suppressing lead diffusion, wherein
the lead diffusion suppression layer is configured to overlap the boundary portion and not to overlap the non-boundary portion when viewed in the first direction, or
a thickness of a portion overlapping the boundary portion when viewed in the first direction is configured to be larger than a thickness of a portion overlapping the non-boundary portion when viewed in the first direction.

9. The liquid discharge head according to claim 8, wherein
the lead diffusion suppression layer contains any one of iridium, platinum, zinc, and hafnium.

10. The liquid discharge head according to claim 1, wherein
a thickness of the boundary portion is larger than a thickness of the non-boundary portion.

11. The liquid discharge head according to claim 1, further comprising:
a pressure chamber substrate that is disposed in a second direction opposite to the first direction with respect to the diaphragm and partitions a plurality of pressure chambers to be arrayed, wherein
the boundary portion and the non-boundary portion are adjacent to each other in a direction intersecting with respect to an array direction of the plurality of pressure chambers.

12. The liquid discharge head according to claim 11, wherein
the first electrode is individually provided for the plurality of pressure chambers, and
the second electrode is commonly provided for the plurality of pressure chambers.

13. The liquid discharge head according to claim 11, wherein
the first electrode is commonly provided for the plurality of pressure chambers, and
the second electrode is individually provided for the plurality of pressure chambers.

14. The liquid discharge head according to claim 11, wherein
the boundary portion does not overlap the pressure chamber when viewed in the first direction.

15. A liquid discharge device comprising:
the liquid discharge head according to claim 1; and
a controller that controls a liquid discharge operation by the liquid discharge head.

16. An actuator comprising a diaphragm, a first electrode, a piezoelectric body, and a second electrode which are stacked in this order in a first direction, wherein
a dielectric constant of a boundary portion is smaller than a dielectric constant of a non-boundary portion when a region of the piezoelectric body interposed between the first electrode and the second electrode is set as a first region, a region of the piezoelectric body other than the first region is set as a second region, a portion of the piezoelectric body including at least a part of a boundary between the first region and the second region is set as a boundary portion, and a portion of the piezoelectric body that is different from a boundary portion and is located in the first region is set as the non-boundary portion, a dielectric constant of the boundary portion is smaller than a dielectric constant of the non-boundary portion.

17. An actuator comprising a diaphragm, a first electrode, a piezoelectric body, and a second electrode which are stacked in this order in a first direction, wherein
the piezoelectric body contains lead, and
when a region of the piezoelectric body interposed between the first electrode and the second electrode is set as a first region,
a region of the piezoelectric body other than the first region is set as a second region,
a portion of the piezoelectric body including at least a part of a boundary between the first region and the second region is set as a boundary portion, and
a portion of the piezoelectric body that is different from the boundary portion and is located in the first region is set as a non-boundary portion,
a lead content of the boundary portion is larger than a lead content of the non-boundary portion.
